(19) United States
(12) Patent Application Publication
(10) Pub. No.: US 2024/0165942 A1
(43) Pub. Date: May 23, 2024

(54) CONTINUOUS MANUFACTURING OF A COMPOSITE STRUCTURE

(71) Applicant: Wabash National, L.P., Lafayette, IN (US)

(72) Inventors: Scott Krajca, West Lafayette, IN (US); Joshua Hagan, Orlando, FL (US); Travis S. McCloud, Malabar, FL (US); Scott Storz, Westminster, SC (US); Andrzej Wylezinski, Lafayette, IN (US)

(73) Assignee: Wabash National, L.P., Lafayette, IN (US)

(21) Appl. No.: 18/509,444

(22) Filed: Nov. 15, 2023

Related U.S. Application Data
(60) Provisional application No. 63/426,970, filed on Nov. 21, 2022.
(60) Provisional application No. 63/524,412, filed on Jun. 30, 2023.

(51) Int. Cl. B32B 37/22; B32B 27/06; B32B 27/08; B32B 38/00; B32B 38/18

(52) U.S. Cl. CPC B32B 37/226; B32B 27/065; B32B 27/08; B32B 38/0004; B32B 38/1808; B32B 2250/05; B32B 2250/24; B32B 2250/40; B32B 2305/022; B32B 2398/20; B32B 2605/00

(57) ABSTRACT

A composite structure, such as a composite panel structure for a cargo vehicle, and method of making the same are disclosed. The composite structure includes a core material and at least one resin material. The composite structure is formed through a continuous manufacturing method.

### CROSS-REFERENCE TO RELATED APPLICATIONS

The present application claims the benefit of U.S. Provisional Application Ser. No. 63/426,970, filed Nov. 21, 2022, and U.S. Provisional Application Ser. No. 63/524,412, filed Jun. 30, 2023, the disclosures of which are incorporated herein by reference.

### FIELD OF THE DISCLOSURE

The present disclosure relates generally to composite materials and, more particularly, to composite structures or panels for vehicles formed through a continuous manufacturing method.

### BACKGROUND OF THE DISCLOSURE

Cargo vehicles are used in the transportation industry for transporting many different types of cargo. Certain cargo vehicles may be refrigerated and insulated to transport temperature-sensitive cargo. Cargo vehicles may be constructed using various materials, such as composites, wood, and/or metallic materials. Such materials may form various surfaces of the cargo vehicles such as a floor, nose, side walls, and a roof of a trailer or cargo area and may be formed through discrete molding processes. For example, it is known to use closed molds in a batch or discrete molding process when forming panels to define the floor, nose, side walls, and/or roof of a trailer or cargo area.

### SUMMARY OF THE DISCLOSURE

A composite structure and methods of making the same are provided. The composite structure includes a foam material and polymeric liners which are integrally joined together through a continuous molding process as compared to the known methods of using closed molds in discrete or batch molding processes. As such, the composite structures of the present disclosure may exclude wood and/or continuous layers of metallic material. The composite structure may be used for cargo vehicles and other applications.

According to one embodiment of the present disclosure, a composite structure comprises an outer layer comprised of a first resin material and defining an outermost surface of the composite structure; an inner layer comprised of the first resin material and defining an innermost surface of the composite structure; a core material positioned intermediate the outer and inner layers; and a second resin material in contact with the core material and at least one of the outer layer and the inner layer. The second resin material is different from the first resin material.

The first resin material may be a precured resin material and the second resin material may be a liquid resin material. The first resin material may be a thermoplastic resin material and the second resin material may be a thermoset resin material.

The outer layer generally extends in a first direction and the core material generally extends in a second direction transverse to the first direction.

The composite structure may further comprise a reinforcing material in contact with at least one of the inner layer, the outer layer, or the core material. The reinforcing material has a length and a width. At least one of the length or width may be less than that of the outer layer.

The composite structure may exclude wood. The composite structure may exclude a continuous sheet of metallic material having a generally consistent thickness.

The composite structure may further comprise a reinforcing material. A first layer of the reinforcing material may be in contact with both the outer layer and a first surface of the core material, and a second layer of the reinforcing material may be in contact with both the inner layer and a second surface of the core material.

The composite structure may define a portion of a cargo area for a vehicle. The outer layer may be exposed to ambient air when defining the portion of the cargo area. The inner layer may be exposed to an interior cargo volume of the cargo area when defining the portion of the cargo area.

According to another embodiment, a method of manufacturing a composite structure comprises providing a linear conveyor system having at least a first zone, a second zone, and a third zone, where the first, second, and third zones are linearly aligned with each other; providing a first layer of precured resin material in the first zone; providing a core material in the first zone, the core material being configured as foam preforms; receiving the core material onto the precured resin material in the first zone in a direction transverse to the linear conveyor system; providing a second layer of precured resin material in the first zone; receiving the second layer of precured resin material on the core material in the first zone; integrally forming the composite structure from the first layer, the core material, and the second layer in the second zone; cutting the formed composite structure to a predetermined size in the third zone; and removing the cut composite structure from the linear conveyor in the third zone.

The precured resin material may be a thermoplastic material.

Integrally forming the composite structure may include applying at least one of heat or pressure to the first layer, the core material, and the second layer while the first layer, the core material, and the second layer move together through the second zone.

The conveyor may move through the first, second, and third zones at a non-zero speed.

The method may further comprise providing a non-cured resin material in the first zone and applying the non-cured resin material to at least the core material.

According to a further embodiment, a method of forming a composite structure comprises providing a first layer of a thermoplastic resin material; providing discontinuous core materials onto the first layer; providing a second layer of the thermoplastic resin material onto the discontinuous core materials; providing a thermoset resin material to at least one of the first layer, the second layer, or the core materials. Excess quantities of the thermoset resin material not provided to at least one of the first layer, the second layer, or the core materials are not recycled. The method further comprises curing the thermoset resin material separately from curing the thermoplastic resin material to integrally form the composite structure from the first layer, the core material, the second layer, and the thermoset resin material.

The discontinuous core materials may be a plurality of discrete core panels positioned transversely to a direction of the first layer. The method may further comprise providing a conveyor for directly receiving the first layer and moving the conveyor at a predetermined, non-zero speed along a linear movement axis, wherein providing the discontinuous core materials may include positioning the discrete core panels transversely to the linear movement axis of the conveyor. Providing the discontinuous core materials may include robotically providing the plurality of discrete core panels onto the first layer.

The method may further comprise providing a thermoset resin supply, wherein providing the thermoset resin material to at least one of the first layer, the second layer, or the core materials includes spraying the thermoset resin material from the thermoset resin supply onto at least one of the first layer, the second layer, or the core materials, and the excess quantities of the thermoset resin material are not recirculated to the thermoset resin supply.

The method may further comprise cutting the formed composite structure to a predetermined size and sealing edges of the cut composite structure where exposed core materials are present. The method may further comprise providing a conveyor for directly receiving the first layer, moving the conveyor at a predetermined, non-zero speed along a linear movement axis, and inspecting the formed composite structure while the formed composite structure is moving on the conveyor at the predetermined, non-zero speed.

According to yet another embodiment, a method of forming a composite structure, the method comprising providing a manufacturing surface having a first direction; providing a first layer of resin material on the manufacturing surface; providing discontinuous core materials onto the first layer; providing a second layer of resin material onto the core materials, wherein excess quantities of the resin material not provided to at least one of the first layer, the second layer, or the core materials are not recycled; curing the first layer of resin material and the second layer of resin material to form a composite material; removing the composite material from the manufacturing surface; and maintaining the first layer of resin, the core materials, and the second layer of resin material in the first direction when forming the composite material, wherein the composite material is removed from the manufacturing surface while extending in the first direction.

Additional features and advantages of the present invention will become apparent to those skilled in the art upon consideration of the following detailed description of the illustrative embodiments exemplifying the best mode of carrying out the invention as presently perceived.

### BRIEF DESCRIPTION OF THE DRAWINGS

The foregoing aspects and many of the intended advantages of this invention will become more readily appreciated as the same becomes better understood by reference to the following detailed description when taken in conjunction with the accompanying drawings.

FIG. 1A is a rear left perspective view of a trailer of a cargo vehicle;

FIG. 1B is a front left perspective view of a cargo vehicle;

FIG. 1C is a front left perspective view of a further cargo vehicle;

FIG. 2 is a perspective view of a composite structure forming a part of the cargo vehicles of FIGS. 1A-1C;

FIG. 3 is a perspective view of a portion of the composite structure of FIG. 2;

FIG. 4 is a schematic view of the trailer or cargo area of the vehicles of FIGS. 1A-1C formed of the composite structure of FIG. 2;

FIG. 5 is a schematic side view of a first embodiment of a continuous manufacturing line and method for forming the composite structure of FIG. 2;

FIG. 6 is a further schematic side view of the first embodiment continuous manufacturing line of FIG. 5 and method for forming the composite structure of FIG. 2;

FIG. 7A is a schematic side view of a second embodiment of a continuous manufacturing line and method for forming the composite structure of FIG. 2;

FIG. 7B is a top view of the second embodiment of FIG. 7A;

FIG. 8 is a schematic top view of a third embodiment of a continuous manufacturing line and method for forming the composite structure of FIG. 2;

FIG. 9A is a schematic top perspective view of a fourth embodiment of a continuous manufacturing line and method for forming the composite structure of FIG. 2;

FIG. 9B is a top view of the fourth embodiment of FIG. 9A;

FIG. 9C is a side view of the fourth embodiment of FIG. 9A;

FIG. 9D is a top perspective view of a first zone or portion of the fourth embodiment of FIG. 9A;

FIG. 9E is a side perspective view of a second zone or portion of the fourth embodiment of FIG. 9A;

FIG. 9F is a top perspective view of a third zone or portion of the fourth embodiment of FIG. 9A;

FIG. 10A is a schematic top perspective view of a fifth embodiment of a continuous manufacturing line and method for forming the composite structure of FIG. 2;

FIG. 10B is a further top perspective view of the fifth embodiment of FIG. 10A with an alternative core supply configuration;

FIG. 10C is another top perspective view of the fifth embodiment of FIG. 10A with a further alternative core supply configuration;

FIG. 10D is a perspective view of a side of the fifth embodiment of FIG. 10A with an alternative scuff supply configuration;

FIG. 10E is a top view of the fifth embodiment of FIG. 10A;

FIG. 10F is a side view of the fifth embodiment of FIG. 10A;

FIG. 10G is a perspective view of a materials zone or portion of the fifth embodiment of FIG. 10A;

FIG. 10H is a top perspective view of a first processing zone or portion of the fifth embodiment of FIG. 10A;

FIG. 10I is a top perspective view of a second processing zone or portion of the fifth embodiment of FIG. 10A;

FIG. 10J is a top perspective view of a third processing zone or portion of the fifth embodiment of FIG. 10A;

FIG. 11A is a schematic top perspective view of a sixth embodiment of a continuous manufacturing line and method for forming the composite structure of FIG. 2;

FIG. 11B is a side view of a materials zone or portion of the sixth embodiment of FIG. 11A;

FIG. 11C is a side view of a first processing zone or portion of the sixth embodiment of FIG. 11A;

FIG. 11D is a top perspective view of a second processing zone or portion of the sixth embodiment of FIG. 11A;

FIG. 11E is a top perspective view of a third processing zone or portion of the sixth embodiment of FIG. 11A; and

FIG. 12 is a flow chart of a method of forming or manufacturing the composite structure of FIG. 2.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

For the purposes of promoting an understanding of the principals of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrative devices and described methods and further applications of the principles of the invention which would normally occur to one skilled in the art to which the invention relates.

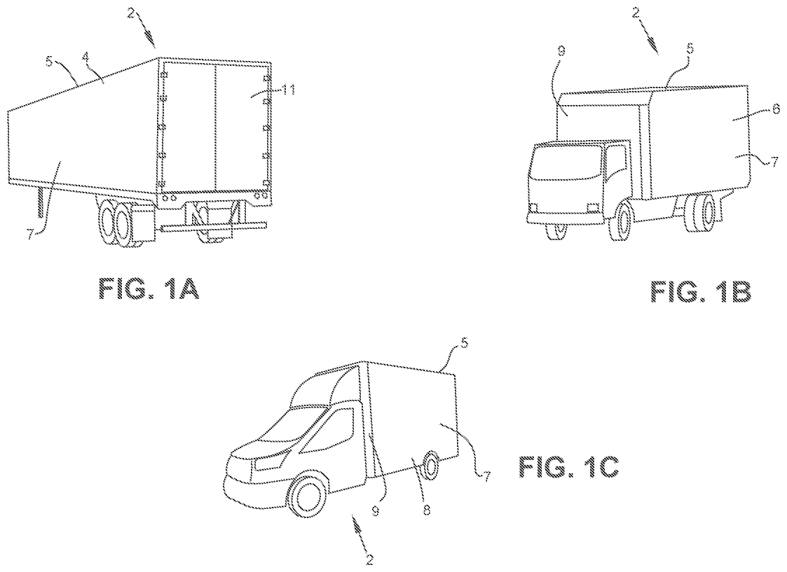

Referring to FIGS. 1A-1C, various embodiments of a cargo vehicle are disclosed. Illustratively, a cargo vehicle 2 may be configured as a truck with a cargo trailer or truck body or as a cargo van. For example, as shown in FIG. 1A, cargo vehicle 2 may be configured as a semi-truck with a trailer 4 (e.g., refrigerated semi trailers, dry freight semi trailers, flatbed semi trailers) configured to transport cargo therein. FIG. 1B illustrates that cargo vehicle 2 may be a box truck with a truck body 6 configured to transport cargo therein. As another example, FIG. 1C illustrates that cargo vehicle 2 may be a cargo or delivery van with a cargo area 8 configured to transport cargo therein. The present disclosure may be applicable to other vehicles or applications, such as dump trailers, storage units, temporary shelters, military platforms, air and space vehicles, automobiles, bridge decks, or buildings, for example. Accordingly, those skilled in the art will appreciate that the present disclosure may be implemented in a number of different applications and embodiments and is not specifically limited in its application to the particular embodiments depicted herein.

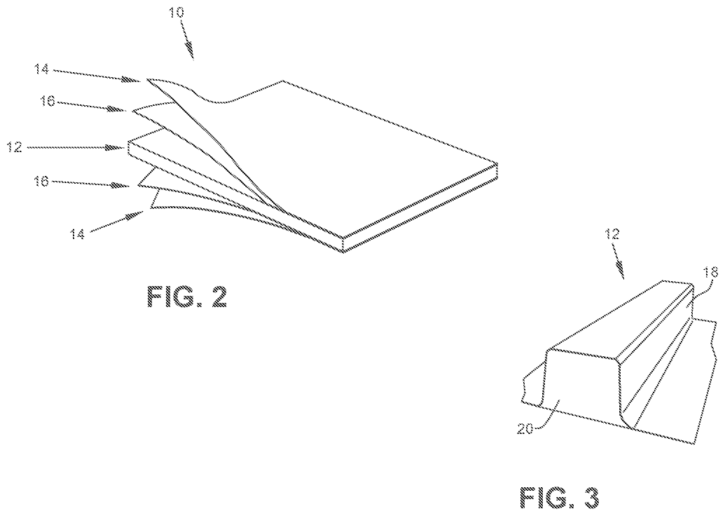

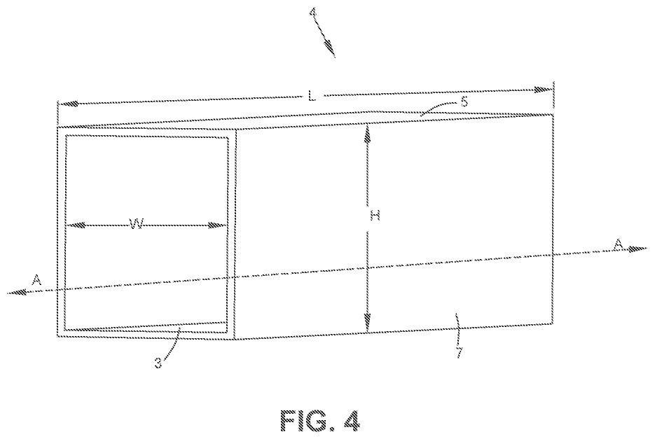

Referring to FIGS. 2 and 3, various portions of trailer 4, truck body 6, and/or cargo area 8 (FIGS. 1A-1C), such as a roof 5, side walls 7, a nose wall 9, a rear wall or door 11, and/or a floor 3 (FIG. 4), may be comprised of a composite structure 10. Known composite structures may include a metal surface, a fabric-reinforced plastic, and an adhesive, as disclosed in U.S. patent application Ser. No. 17/019,605, filed Sep. 14, 2020, and entitled “COMPOSITE STRUCTURE WITH MOLDED-IN WOOD SURFACE” (Attorney Docket No.: WNC-2019-20-02-US), the complete disclosure of which is expressly incorporated by reference herein. However, as shown in FIG. 2, composite structure 10 of the present disclosure may exclude any wood or continuous metal panels or layers and, instead, illustratively is comprised of at least a core material 12, which may be a foam material, and at least one liner material 14. However, in various embodiments, composite structure 10 may have discrete sections or portions of embedded wood or metal portions as hardpoint locations without departing from the intention of the present disclosure. In one embodiment, two layers or panels of liner material 14 may be included and positioned on opposing sides of core material 12. A doubler material 16 also may be used for composite structure 10. For example, doubler material 16 may be positioned intermediate liner material 14 and core material 12 and, where two layers of liner material 14 are included, two layers of doubler material 16 also may be included.

As shown in FIG. 2, composite structure 10 may form a panel having a generally planar surface with liner material 14 defining the exterior and interior surfaces of the panel and core material 12 and doubler material 16 positioned intermediate liner materials 14. The panel configuration of composite structure 10 may have a generally square or rectangular shape, although this shape may vary. A plurality of composite structures 10 may be joined together to form the cargo area of cargo vehicle 2 (e.g., trailer 4, truck body 6, cargo area 8). In at least the embodiment of FIG. 4, the plurality of composite structures 10 may be integrally formed or joined together to generally define a one-piece cargo structure, thereby reducing holes and fasteners between various composite structures 10. Referring still to FIG. 4, the cargo area of cargo vehicle 2 may ultimately have a width W, a height H, and a length L, and length L, height H, and width W may vary depending on the needs of the particular application. As shown in at least FIG. 4, length L may extend generally along a longitudinal axis A of the cargo area (e.g., trailer 4) between nose wall 9 and rear wall or door 11. Width W may be defined by opposing side walls 7. Height H may be defined as the distance between roof 5 and floor 3.

### 1. Foam Material

Core material 12 may be configured as a continuous layer or panel of foam or may be configured as discrete or discontinuous transverse beams formed of a composite material. As disclosed further herein, core material 12 also may be referred to herein as a composite structure. As noted herein, these composite structures of the present disclosure may lack metal components. Also, each composite structure may be a single, unitary component, which may be formed from a plurality of layers permanently coupled together. Exemplary composite materials for use in composite structure 10 include fiber-reinforced plastics (FRP), for example carbon-fiber-reinforced plastics (CRP). Core material 12 may provide stiffness and resistance to bending and deflection in the transverse direction of the various cargo areas, for example trailer 4.

Each composite structure, including core material 12, may contain one or more reinforcing layers that contains reinforcing fibers and is capable of being impregnated and/or coated with a reinforcement resin, as disclosed in U.S. patent application Ser. No. 17/019,605, filed Sep. 14, 2020, and entitled “COMPOSITE STRUCTURE WITH MOLDED-IN WOOD SURFACE” (Attorney Docket No.: WNC-2019-20-02-US), the complete disclosure of which is expressly incorporated by reference herein. Suitable fibers include carbon fibers, glass fibers, cellulose, or polymers, for example. The fibers may present in fabric form, which may be matt, woven, non-woven, or chopped, for example. Exemplary reinforcing layers include chopped fiber fabrics, such as chopped strand mats (CSM), and continuous fiber fabrics, such as 0°/90° fiberglass fabrics, +45°/−45° fiberglass fabrics, +60°/−60° fiberglass fabrics, 0° warp unidirectional fiberglass fabrics, and other stitched fiber fabrics, for example.

According to an exemplary embodiment of the present disclosure, a plurality of different reinforcing materials may be stacked together and used in combination. For example, a chopped fiber fabric (e.g., CSM) may be positioned adjacent to a continuous fiber fabric. In this stacked arrangement, the chopped fibers may help support and maintain the adjacent continuous fibers in place, especially around corners or other transitions. Also, the chopped fibers may serve as a web to resist column-type loads in compression, while the adjacent continuous fibers may resist flange-type loads in compression. Adjacent reinforcing layers may be stitched or otherwise coupled together to simplify manufacturing, to ensure proper placement, and to prevent shifting and/or bunching.

Also, in certain embodiments, core material 12 is in the form of a preform which includes a structural core 20 that has been covered with an outer fabric layer or skin 18. Core 20 may be extruded, pultruded, or otherwise formed into a desired shape and cut to a desired length. In an exemplary embodiment, core 20 is a polyurethane foam material or another foam material, and outer skin 18 is a spun bond polyester material. Advantageously, in addition to its structural effect, core 20 may have an insulating effect in certain applications, including refrigerated trucking applications. Both core 20 and outer skin 18 may be selected to accommodate the needs of the particular application.

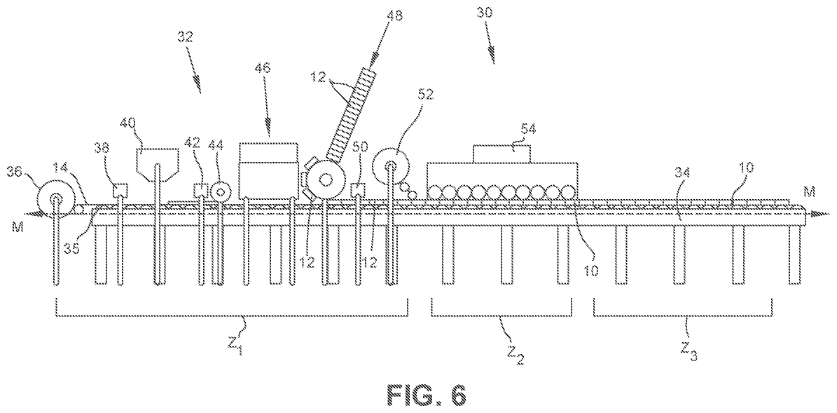

In various embodiments, core material 12, whether in the form of the preform of FIG. 3 or as a continuous sheet or panel, may have a thickness of approximately 0.5 to approximately six inches and, more particularly, approximately 1.5-4 inches. Additionally, the length of core material 12 may be approximately equal to the width of liner material 14 and/or composite structure 10 such that composite structure 10 includes an edge-to-edge configuration of core material 12. The width of liner material 14 and composite structure 10 is generally perpendicular to an axis of movement M (FIG. 6) of a conveyor of the manufacturing lines disclosed herein.

### 2. Liner Material

Referring still to FIG. 2, liner material 14 may be comprised of a polymeric material, for example a polymeric resin. In one embodiment, liner material 14 is comprised of a thermoplastic resin which may be applied as a precured or solid layer to core material 12 or may be applied to core material 12 as a liquid and cured throughout the manufacturing process of composite structure 10. It may be appreciated that liner material 14 is cured separately and independently of the various thermoset resins disclosed herein. In various embodiments, liner material 14 include a thickness of approximately 0.010 inch to 0.100 inch and, more particularly, approximately 0.018-0.085 inch. Liner material 14 generally defines outer and inner surfaces of composite structure 10 and, as such, with respect to trailer 4 (FIG. 1A) may define the outermost surface thereof exposed to ambient air and the innermost surface thereof exposed to the open volume of the cargo area. In various embodiments, liner material 14 may be completely flat or textured (e.g., dimpled or ridged) to provide a slip-resistant surface. During the manufacturing processes disclosed herein, it is apparent that liner material 14 is adhered or bonded to core material 12, either directly or through doubler material 16. More particularly, liner material 14 may include a scrim layer for mechanically bonding with the resin material disclosed herein such that no additional adhesives are needed when forming composite structure 10.

### 3. Doubler Material

As shown in FIG. 2, doubler material 16 is a reinforcing material configured to provide additional strength properties at various locations of composite structure 10, for example at predetermined mounting locations along the length or width of composite structure 10. Doubler material 16 may be positioned intermediate core material 12 and liner material 14 such that one surface of doubler material 16 may be in direct contact with liner material 14 while the opposing surface of doubler material 16 may be in direct contact with core material 12. Doubler material 16 may be positioned on opposing sides of core material 12 such that two layers of doubler material 16 are included in composite structure 10. In one embodiment, doubler material 16 is formed of a fiberglass material, as disclosed herein, and may be applied to core material 12 and/or liner material 14 as a continuous sheet, panel, or layer or may be applied in discrete sections such as when doubler material 16 is in the form of a chopped fiberglass mat. Further, doubler material 16 may be positioned only along a partial length and/or width of liner material 14 which are generally indicative of reinforced mounting locations of composite structure 10.

### 4. Resin

Composite structure 10 includes a second resin material applied (e.g., sprayed via a spray gun) to various other materials of composite structure 10. In one embodiment, resin material may be a liquid/uncured material, such as an unsaturated polyester material, and, as such, may be cured separately and independently from any curing required of liner material 14. Additional resin or adhesive materials are disclosed herein and, in some embodiments, such resin materials may cure within a sufficiently short amount of time after application onto the various materials of composite structure 10 to prevent excess resin from being recycled and used later during the manufacturing method. The resin materials may be used for wetting various raw materials such as core material 12, liner material 14, and/or doubler material 16 and/or may be used during the edge sealing process disclosed further herein.

In an illustrative embodiment, the resin may comprise one or more elastomer components, such as urethane, vinyl ester, epoxy, or unsaturated polyester components. Exemplary materials are disclosed in U.S. Pat. Nos. 9,371,468 and 10,596,791, the disclosures of which are hereby incorporated by reference in their entirety.

Exemplary polyester and vinyl esters are produced by combining an unsaturated polyester resin or vinyl ester resin with an ethylenic monomer, usually styrene, and a free-radical initiator. Exemplary unsaturated polyester resins include polymers of intermediate molecular weight made by condensing glycols, maleic anhydride, and dicarboxylic acids or their anhydrides to produce a resin. Exemplary glycols include ethylene glycol, propylene glycol, diethylene glycol, dipropylene glycol, alkoxylated bisphenol A, cyclohexane dimethanol, and neopentyl glycol. Maleic anhydride provides a crosslinkable carbon-carbon double bond capable of reacting with the ethylenic monomer in the presence of the free-radical initiator. Exemplary dicarboxylic acids and anhydrides include phthalic anhydride, isophthalic acid (which produces an isophthalic polyester resin), terephthalic acid, adipic acid, succinic acid, tetrabromophthalic anhydride, tetrahydrophthalic anhydride, maleic acid, fumaric acid, and the like.

Exemplary ethylenic monomers include, for example styrene, α-methylstyrene, divinylbenzene, methyl methacrylate, butyl acrylate, and vinyl toluene. In one exemplary embodiment, the ethylenic monomer is styrene.

Exemplary vinyl esters are formed from a reaction of an epoxy resin and an unsaturated carboxylic acid such as acrylic acid or methacrylic acid. In one exemplary embodiment, the epoxy resin is a product of bisphenol A with epichlorohydrin, further reacted with methacrylic acid to convert the epoxide end groups to vinyl ester groups.

Exemplary epoxies are formed from a reaction of an epoxy resin, such as a diglycidyl ether reaction product of bisphenol A with epichlorohydrin, with a curing agent such as an aromatic diamine. Exemplary curing agents for epoxy resins include aliphatic amines, cycloaliphatic amines, aromatic amines, polyamides, amidoamines, polysulfides, and anhydrides. In one exemplary embodiment, the resin components include an epoxy and an unsaturated polyester resin, such as isophthalic polyester resin, in combination.

In one exemplary embodiment, the resin includes as little as 5 wt. %, 10 wt. %, 15 wt. %, 20 wt. %, 25 wt. %, 30 wt. %, as great as 40 wt. %, 50 wt. %, 60 wt. %, 70 wt. %, 80 wt. %, 90 wt. %, or 95 wt. % of the urethane component based on the total weight of the resin, or within any range defined between any two of the foregoing values, such as 5 wt. % to 95 wt. %, 10 wt. % to 25 wt. %, 15 wt. % to 25 wt. %, or 50 wt. % to 95 wt. %.

In one exemplary embodiment, the resin includes as little as 5 wt. %, 10 wt. %, 20 wt. %, 30 wt. %, 40 wt. %, 50 wt. %, as great as 60 wt. %, 70 wt. %, 75 wt. %, 80 wt. %, 85 wt. %, 90 wt. %, or 95 wt. % of the one or more resin components, such as vinyl ester, epoxy, or unsaturated polyester component, based on the total weight of the resin, or within any range defined between any two of the foregoing values, such as 5 wt. % to 95 wt. %, 75 wt. % to 90 wt. %, or 5 wt. % to 50 wt. %.

### 5. Continuous Fabrication Process

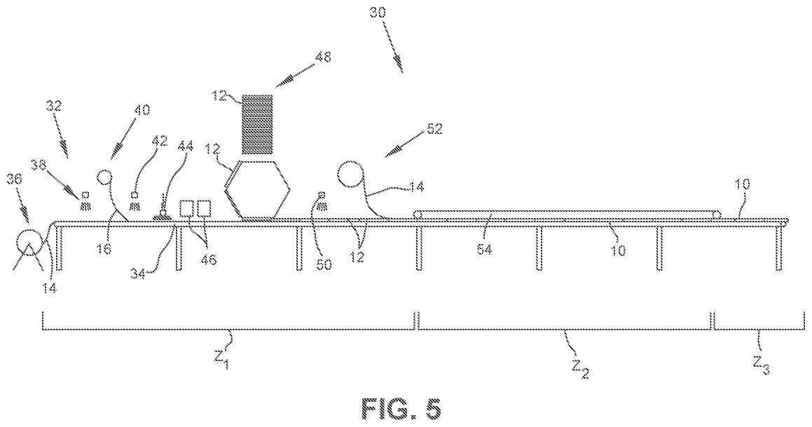

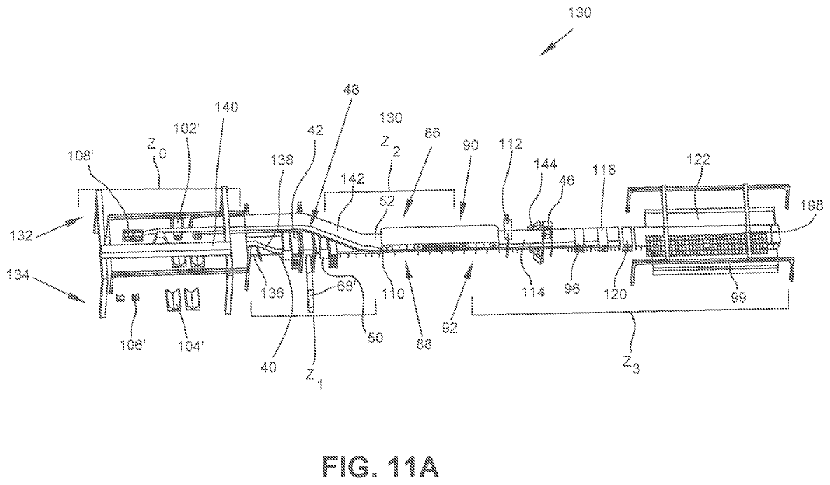

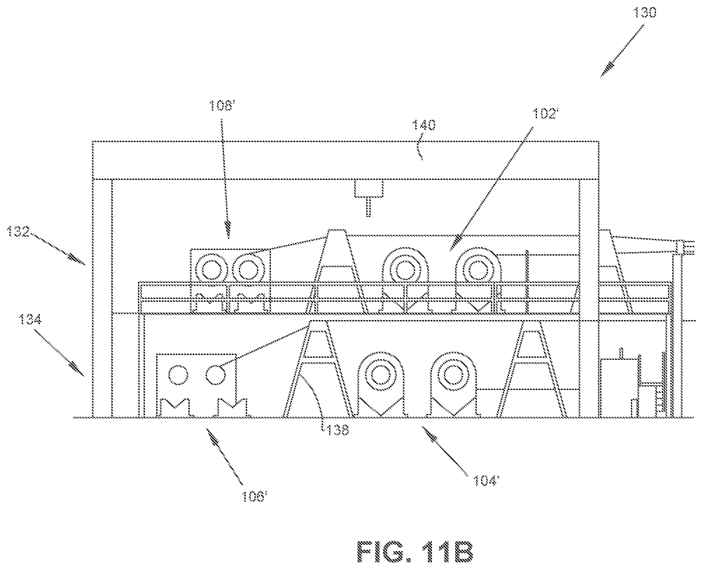

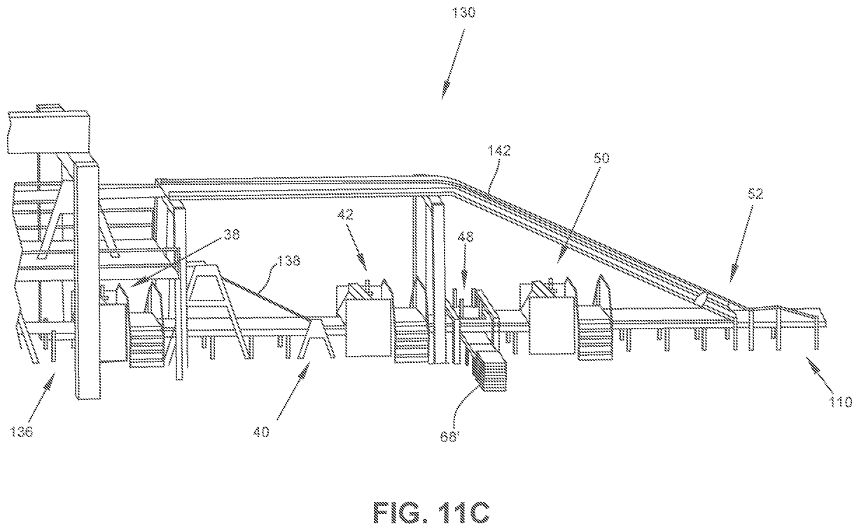

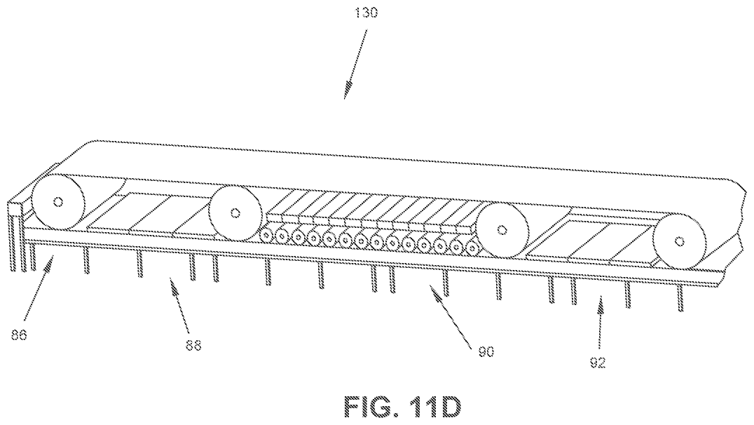

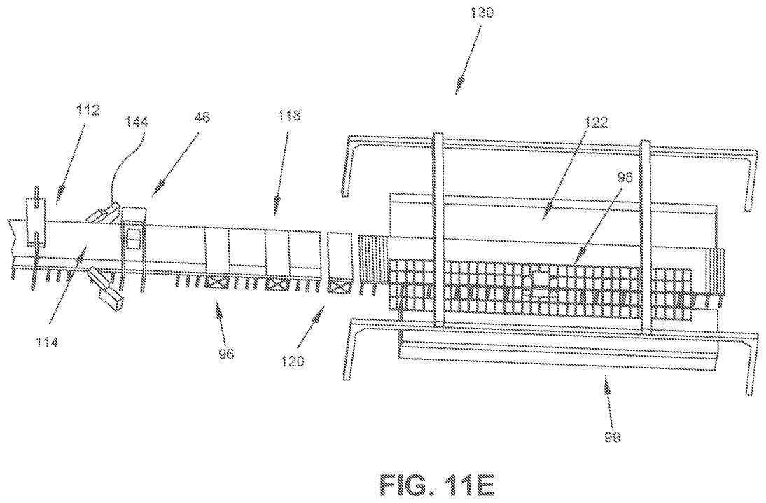

Referring next to FIGS. 5-11, composite structure 10 may be formed by a fabrication process 30 (e.g., FIG. 11). Fabrication process 30 is a continuous, in-line method or process which allows composite structure 10 to be formed at any length and formed continuously without discrete size limitations or time and quantity restrictions of conventional batch molding processes. More particularly, fabrication process 30 allows composite structure 10 to be fully formed from raw materials and fully processed to a predetermined size/shape for immediate installation on cargo vehicle 2 (or any other application) before being removed from the various embodiments of manufacturing lines disclosed herein such that no secondary processing steps are needed in the interim from when composite structure 10 is removed from the manufacturing lines of the present disclosure and is ready for installation onto a vehicle (or for another application).

Referring initially to FIGS. 5 and 6, a first embodiment continuous manufacturing line 32 is disclosed for forming composite structure 10 through fabrication process 30. Manufacturing line 32 may include a table or support surface 34 configured to support the various materials comprising composite structure 10 and any equipment for providing such materials and/or forming composite structure 10. For example, support surface 34 includes or otherwise supports a conveyor 35 (e.g., a belt) (FIG. 6) which has a generally linear axis of movement M for continuously moving various materials along the length of support surface 34 at a predetermined speed. More particularly, support surface 34 and conveyor 35 are generally in a linear configuration such that all processing zones thereof are linearly aligned or in-line with each other. Along the length of support surface 34, manufacturing line 32 may generally define discrete zones related to fabrication process 30. As shown, manufacturing line 32 may include three zones, where a zone 1 is shown as Z₁ and generally relates to forming or fabricating the materials and general structure of composite structure 10, a zone 2 is shown as Z₂ and generally relates to consolidating and integrally joining together the materials of composite structure 10 (e.g., through pressure and/or temperature), and a zone 3 is shown as Z₃ and generally relates to final processing of composite structure 10 in preparation for its intended application, which may include trimming portions of composite structure 10 and allows composite structure 10 to exit manufacturing line 32.

Illustratively, as part of zone 1 (Z₁), a liner supply 36 is positioned at or adjacent the start of manufacturing line 32 (i.e., at a head or starting/front end of support surface 34). Liner supply 36 is configured to provide liner material 14, where liner material 14 may be considered a first resin material. As disclosed herein, liner material 14 may be provided by liner supply 36 as a precured or solid resin liner material 14 (e.g., liner material 14 on a roll or spool defining at least part of liner supply 36); however, liner supply 36 may be configured to provide liner material 14 in any form (e.g., solid or liquid) depending on the application of composite structure 10 and/or fabrication process 30. For example, in at least one embodiment, liner material 14 may be partially supplied through a wet-out or spray station in which liquid resin is sprayed onto dry fibers and/or reinforcing materials and cures quickly on conveyor 35 so as to generally form a solid layer of composite structure 10 as it moves down conveyor 35. As noted herein, liner material 14 from liner supply 36 may be a thermoplastic material.

Liner material 14 begins moving down support surface 34 via conveyor 35 at a predetermined, non-zero speed and reaches a first resin supply, such as a reciprocator 38, configured to provide a second resin material, illustratively in the form of a liquid/uncured resin, to liner material 14. The liquid resin may be as disclosed in Section 4 herein. Once liner material 14 is wetted with the liquid resin from first reciprocator 38, doubler material 16 may be applied to the wetted liner material 14 by a doubler supply 40 downstream of first reciprocator 38. Doubler supply 40 may be configured as a prekitted doubler supply. Doubler material 16 is a solid material (e.g., fiberglass) that may be applied as a continuous sheet or layer or may be applied as discrete batches of chopped fiberglass mat. Doubler material 16 may be applied to liner material 14 at discrete locations along liner material 14 based on the application of composite structure 10. For example, where composite structure 10 is configured as part of trailer 4, doubler material 16 may be positioned at discrete locations based on mounting locations necessary for trailer 4. In this way, it may not be necessary for composite structure 10 to include doubler material 16 in a continuous length or width that matches the dimensions of liner material 14. From there, doubler material 16 may be wetted by a liquid resin supplied by a second resin supply, such as a reciprocator 42. The liquid resin at second reciprocator 42 may be the same as the liquid resin from first reciprocator 38 or may have a different composition therefrom. Additionally, the quantity or general supply parameters of the liquid resin at second reciprocator 42 may be the same or different from those provided at first reciprocator 38.

Once doubler material 16 is wetted with the resin at second reciprocator 42, pressure may be applied to doubler material 16 and liner material 14 at a pressure supply 44. Illustratively, pressure supply 44 may be in the form of at least one roller but may be configured as any press, roller, or other device configured to apply a predetermined amount of pressure to the wetted liner and doubler materials 14, 16. A curing station 46 may be included downstream of pressure supply 44 and may be any type of device configured to interact with the resin material(s), such as UV lights, heating elements, or any other curing device.

Following curing station 46, manufacturing line 32 includes a core supply 48 (e.g., a foam supply) configured to provide core material 12 to doubler material 16. Core supply 48 may be configured to provide core material 12 in continuous or discrete sheets, panels, or preforms (FIG. 3), as disclosed herein. Illustratively, core supply 48 provides core material 12 in the form of discrete preforms which may be positioned in a generally transverse direction relative to the length of support surface 34 and relative to axis of movement M of conveyor 35. Similarly, the preforms may be generally transverse to a length of liner material 14, where the length of liner material 14 generally extends parallel to axis of movement M of conveyor 35. Core supply 48 may provide the preforms of FIG. 3 in a spaced manner such that the preforms are not in direct contact with each other, however, in other embodiments or applications of composite structure 10, core supply 48 may provide the preforms in a manner in which the preforms directly contact each other with approximately zero space between adjacent preforms. In one embodiment, core supply 48 may be sized to provide a sufficient quantity of core material 12 to create a predetermined length of composite structure 10 (e.g., core supply 48 may be sized to provide the amount of preforms of core material 12 needed to create composite structure 10 in the length L of trailer 4 (FIG. 4)).

Regardless of the form of core material 12, core material 12 is positioned directly on doubler material 16 (or, where doubler material 16 is not used, is positioned directly on liner material 14) and moves along support surface 34 at the speed of conveyor 35. A third resin supply, such as a reciprocator 50, may be positioned downstream of core supply 48 to provide liquid resin to core material 12. As noted herein, the resin from reciprocator 50 may be the same or different from the resins at reciprocators 38, 42 and/or may have different spray or application parameters compared thereto. Once wetted with liquid resin from third reciprocator 50, core material 12 moves along conveyor 35 and a second liner supply 52 provides liner material 14 over the wetted core material 12. If a second layer or batch of doubler material 16 is to be provided, a second doubler supply (not shown) may be provided upstream of second liner supply 52 such that doubler material 16 is directly positioned on the wetted core material 12 and liner material 14 is positioned over the second layer or batch of doubler material 16. A fourth resin supply (not shown) may be used to wet doubler material 16 before application of liner material 14 from second liner supply 52. Second liner supply 52 generally defines the end of zone 1 (Z₁) and approximately defines the general fabrication of composite structure 10.

From zone 1 (Z₁), conveyor 35 maintains its non-zero speed and carries composite structure 10 into zone 2 (Z₂), where composite structure 10 is generally consolidated and receives further processing in the form of heat and/or pressure at a station 54. In this way, zone 2 (Z₂) may be configured as a consolidation and curing zone in which the various materials of composite structure 10 are adhered or integrally joined together as the liquid resin(s) cures and composite structure 10 may be pressed to a specific thickness or otherwise pressed to generally accomplish the forming process. According to various applications of composite structure 10, the pressure applied thereto at station 54 may be carefully calibrated to ensure that composite structure 10 has the correct resultant strength. More particularly, because composite structure 10 does not include wood or any continuous metal layers as other known composite structures do, composite structure 10 is manufactured in such a way to provide the necessary strength for the various applications of composite structure 10.

Following zone 2 (Z₂), composite structure 10 is generally formed as a continuous panel and conveyor 35 moves composite structure 10 to zone 3 (Z₃) for final processing steps, such as trimming composite structure 10. The trimming process may involve trimming away any unnecessary or extra materials from composite structure 10 and cutting composite structure 10 to a specific size to meet various vehicle and other applications. For example, composite structure 10 may be cut to a length equal to length L of trailer 4 (FIG. 4) such that composite structure 10 forms a continuous side wall 7 of trailer 4. Where composite structure 10 is cut and any raw materials of composite structure 10 are exposed (e.g., raw core material 12), a sealing treatment may be provided in zone 3 (Z₃) to prevent water and air intrusion within composite structure 10 which may degrade composite structure 10. Following this final processing on conveyor 35, composite structure 10 may be removed from conveyor 35 and is immediately available for storage or assembly onto a vehicle or use in another application. No further processing steps are required to fully form and complete composite structure 10 according to its intended application.

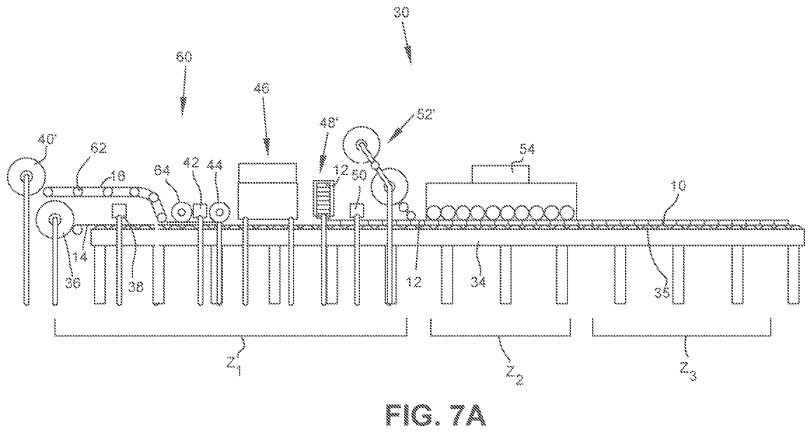

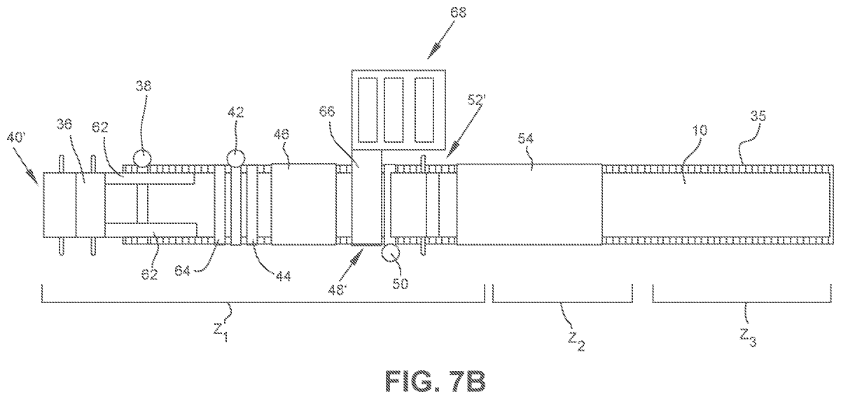

Referring now to FIGS. 7A and 7B, a second embodiment continuous manufacturing line 60 is disclosed for forming composite structure 10. Manufacturing line 60 includes many components and general similarities to manufacturing line 32 (FIGS. 5 and 6) and like components are denoted with like reference numbers/symbols. For example, manufacturing line 60 includes table or support surface 34, liner supply 36, reciprocators 38, 42, 50, pressure supply 44, curing station 46, core supply 48, and station 54 generally in the same locations and orientations as disclosed herein with respect to FIGS. 5 and 6. However, manufacturing line 60 includes an alternative doubler supply shown at 40′. Doubler supply 40′ is illustratively positioned upstream of liner supply 36, however, doubler supply 40′ includes a supply belt 62 configured to provide doubler material 16 at a position downstream of first reciprocator 38. In this way, doubler material 16 is provided on liner material 14 after liner material 14 is wetted with liquid resin from first reciprocator 38, however, the location of doubler supply 40′ may allow for a more compact width or arrangement of manufacturing line 60 generally at the location of first reciprocator 38 because, unlike doubler supply 40 of FIGS. 5 and 6, doubler supply 40′ is positioned at the start of zone 1 (Z₁).

Additionally, manufacturing line 60 may include an additional pressure supply shown at 64. Pressure supply 64 may be positioned upstream of second reciprocator 42 such that pressure supply 64 may press or otherwise supply pressure to doubler material 16 after doubler material 16 is applied to the wetted liner material 14. After pressure is applied by pressure supply 64, second reciprocator 42 applies liquid resin to doubler material 16 before doubler material 16 and liner material 14 are pressed again at pressure supply 44. Pressure supply 64 may be configured as a roller or any other device configured to apply a predetermined amount of pressure to liner and doubler materials 14, 16.

As shown best in FIG. 7B, manufacturing line 60 may include an alternative core supply shown at 48′. Core supply 48′ may include a hopper 66 and a staging area 68. Staging area 68 may be offset from conveyor 35 and not in line with support surface 34. Staging area 68 may be configured to store or otherwise hold excess quantities of core material 12 (e.g., preforms (FIG. 3)) while hopper 66 is configured to supply core material 12 to liner and doubler materials 14, 16 on conveyor 35 in a manner similar to that of manufacturing line 32 (FIGS. 5 and 6). Hopper 66 allows for additional automation of manufacturing line 60 because hopper 66 provides core material 12 to conveyor 35 without the need for human intervention.

Downstream of core supply 48′, manufacturing line 60 further includes an alternative second liner supply shown at 52′. Second liner supply 52′ is generally downstream of third reciprocator 50 so as to apply liner material 14 to core material 12 which has been wetted with resin from reciprocator 50. Illustratively, second liner supply 52′ may be a double roller supply which may allow overlapping materials to be spliced into liner material 14 and/or otherwise applied to core material 12 at the location of second liner supply 52′. It may be appreciated that the overlapped splices will be tracked along conveyor 35 and may be removed (e.g., cut) from composite structure 10 in Zone 3 (Z₃). As with manufacturing line 32 of FIGS. 5 and 6, once liner material 14 has been applied to core material 12 at second liner supply 52′, the general configuration of composite structure 10 is complete and enters zone 2 (Z₂) for curing and compaction via pressure and heating devices at station 54. From there, composite structure 10 is complete and ready for zone 3 (Z₃) for trimming and final cutting within zone 3 (Z₃) before exiting manufacturing line 60.

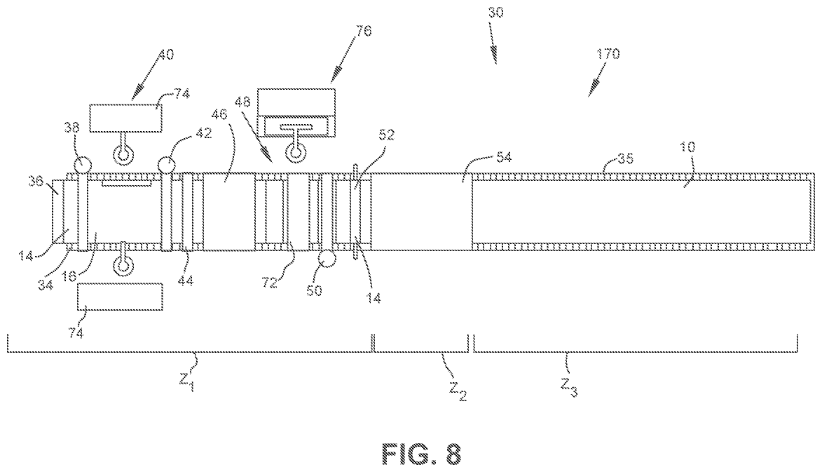

Referring now to FIG. 8, a third embodiment continuous manufacturing line 70 is disclosed for forming composite structure 10. Manufacturing line 70 includes many components and general similarities to manufacturing line 32 (FIGS. 5 and 6) and manufacturing line 60 (FIGS. 7A and 7B) and like components are denoted with like reference numbers/symbols. For example, manufacturing line 70 includes table or support surface 34, liner supply 36, doubler supply 40, reciprocators 38, 42, 50, pressure supply 44, curing station 46, core supply 48, and station 54 generally in the same locations and orientations as disclosed herein with respect to FIGS. 5 and 6. However, manufacturing line 60 includes an additional pressure supply shown at 72. Pressure supply 72 may be positioned generally at or adjacent core supply 48 such that pressure may be applied for compacting core material 12 upstream of third reciprocator 50 and station 54.

Continuous manufacturing line 70 may use robotic arms or other robotic/automated device to eliminate the need to manually feed materials through cassettes or drums and to efficiently prepare or load supply equipment with any of materials 12, 14, 16. In this way, loading any staging areas, hoppers, or other equipment with materials 12, 14, 16 can occur off-line from support surface 34. For example, doubler supply 40 may include robotic equipment 74 to prepare and/or feed doubler material 16 into the system of continuous manufacturing line 70. Further, in another example, core supply 48 may include robotic equipment 76 to prepare and/or feed core material 12 (e.g., the preforms of FIG. 3) into the system of manufacturing line 70. Robotic equipment 74, 76 may include or be positioned on rails, sliders, or other moveable components to allow robotic equipment 74, 76 to match any speed or rate of conveyor 35.

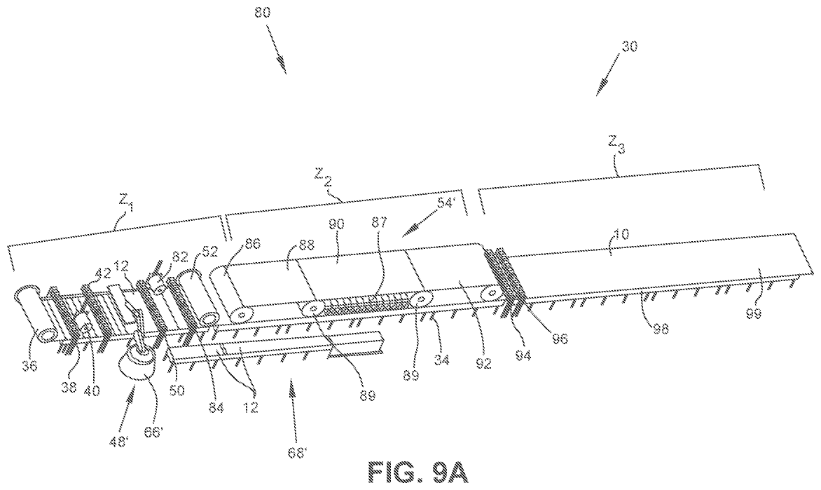

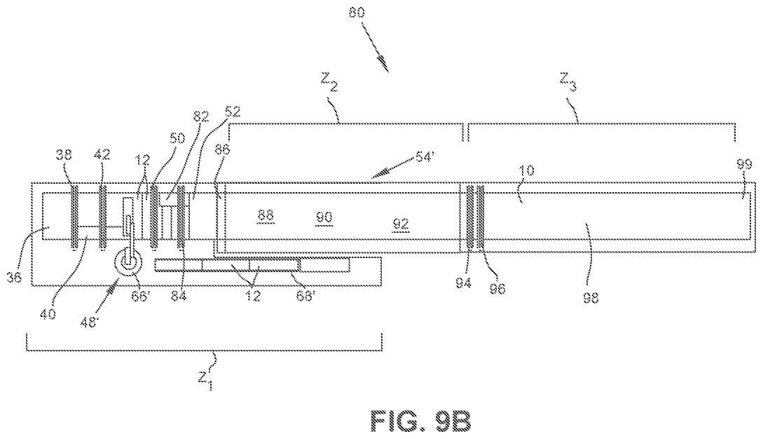

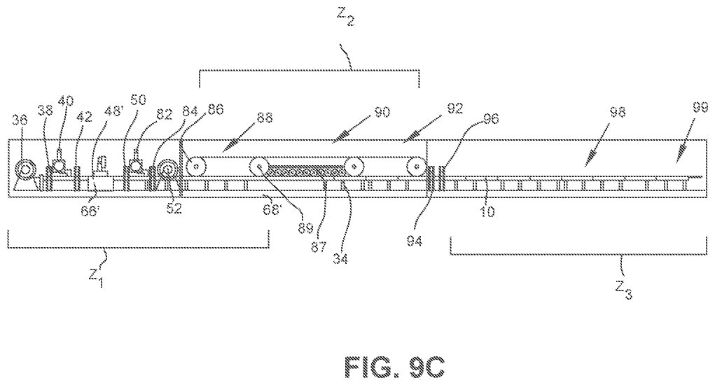

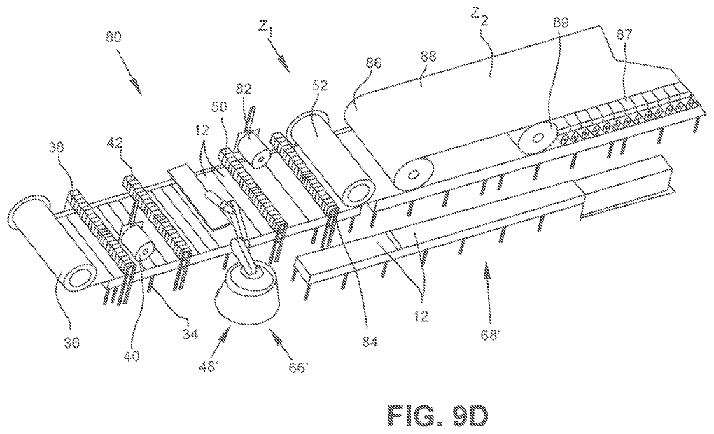

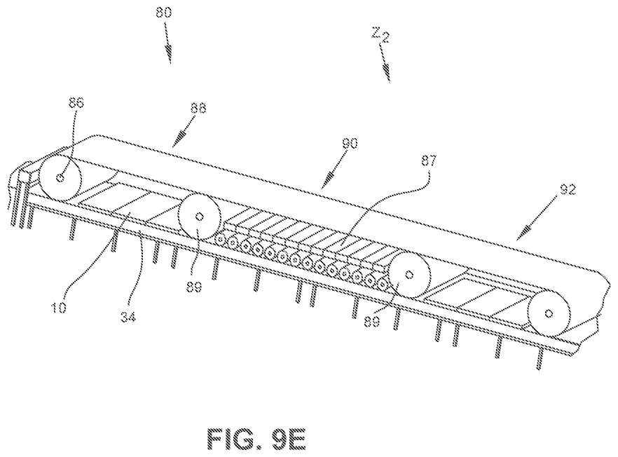

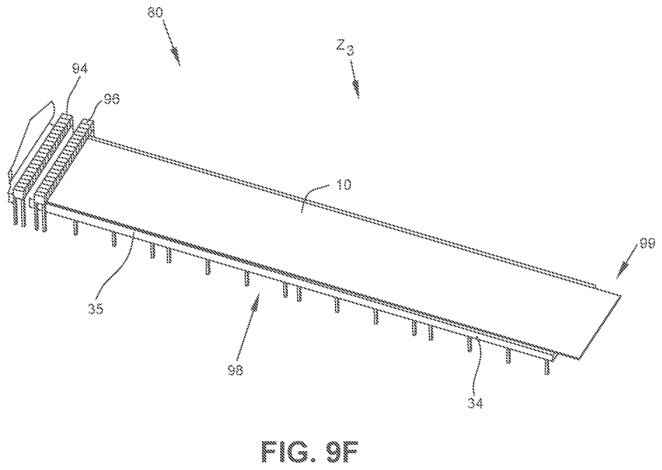

Referring now to FIGS. 9A-9F, a fourth embodiment continuous manufacturing line 80 is disclosed for forming composite structure 10. Manufacturing line 80 includes many components and general similarities to manufacturing line 32 (FIGS. 5 and 6), manufacturing line 60 (FIGS. 7A and 7B), and manufacturing line 70 (FIG. 8), where like components are denoted with like reference numbers/symbols. Manufacturing line 80 includes liner supply 36, first reciprocator 38, doubler supply 40, second reciprocator 42, core supply 48′, third reciprocator 50, and second liner supply 52 all generally in a respective downstream order within zone 1 (Z₁). Core supply 48′ of manufacturing line 80 may include a staging area 68′ in the configuration of a conveyor for providing core material 12 (e.g., preforms (FIG. 3) to a hopper 66′ of core supply 48′.

However, zone 1 (Z₁) also may include additional components as shown throughout FIGS. 9A-9F, such as a second doubler supply 82 positioned downstream of core supply 48′ and third reciprocator 50 such that additional doubler material 16 is positioned on the resin-wetted core material 12 before leaving zone 1 (Z₁). Zone 1 (Z₁) also may include a fourth resin supply or reciprocator 84 positioned downstream of second doubler supply 82 to apply liquid resin onto doubler material 16 before second liner supply 52 applies liner material 14 to the resin-wetted doubler material 16.

Zone 1 (Z₁) generally ends with second liner supply 52 and composite structure 10 receives further processing in the form of heat and/or pressure at a station 54′ within zone 2 (Z₂). Station 54′ includes a first or initial compaction zone at a compaction or pressure device 86. Compaction device 86 may be in the form of a roller, a press, or other device configured to apply a predetermined amount of pressure to composite structure 10. Station 54′ also includes a heating and/or pressure station at 88 configured to supply a predetermined amount of heat and/or pressure to composite structure 10 downstream of compaction device 86. Following heating station 88, a compression and curing zone is shown at 90 and may include a pressure device (e.g., roller(s), press(es), or other compaction or pressure devices generally shown at 89) and a temperature device generally shown at 87, such as a heater or oven, to both further compact composite structure 10 and cure the liquid resin from any of reciprocators 38, 42, 50, 84. In one embodiment, compression and curing zone 90 may be eliminated or combined with heating and/or pressure station 88 such that Zone 2 (Z₂) includes only one station configured to provide heating and/or pressure. The final zone or area of zone 2 (Z₂) includes a cooling zone at 92.

After composite structure 10 leaves cooling zone 92, through the movement of conveyor 35, composite structure 10 enters zone 3 (Z₃) for final processing, such as trimming and/or cutting to a predetermined size as disclosed herein. Illustratively, manufacturing line 80 includes a trimming station at 94 configured to trim the ends of composite structure 10 and/or trim or cut composite structure 10 to a predetermined size. After trimming or cutting at station 94, composite structure 10 may include raw or exposed edges where, for example, raw core material 12 is exposed to ambient air. To prevent fluid intrusion, such as from water or air, which may degrade core material 12, the exposed edges may be sealed at a sealing station 96. More particularly, station 96 may seal the exposed edges with a urethane adhesive material, an ultraviolet resin material, or any material capable of sealing the edges from fluid intrusion. Once the edges are sealed at station 96, composite structure 10 moves on conveyor 35 to a station 98 where the full length of composite structure 10 is exposed. The full length of composite structure 10 may match the length of trailer 4 (FIG. 4), for example, and, in some embodiments, may be approximately 53 feet in length. For other applications, such as for truck body 6 or cargo area 8 (FIGS. 1B and 1C), the full length of composite structure 10 may equal the length of side walls 7 thereof. It may be appreciated that within zone 3 (Z₃) composite structure 10 may be cut or trimmed to any predetermined size based on the application of vehicle 2. Finally, at a station 99, the trimmed/cut composite structure 10 is removed from conveyor 35 and moved to any further location or stage depending on the application of composite structure 10. For instance, composite structure 10 may be moved to a facilitate for storage, may be moved to a location for assembly as part of trailer 4, truck body 6, or cargo area 8, etc.

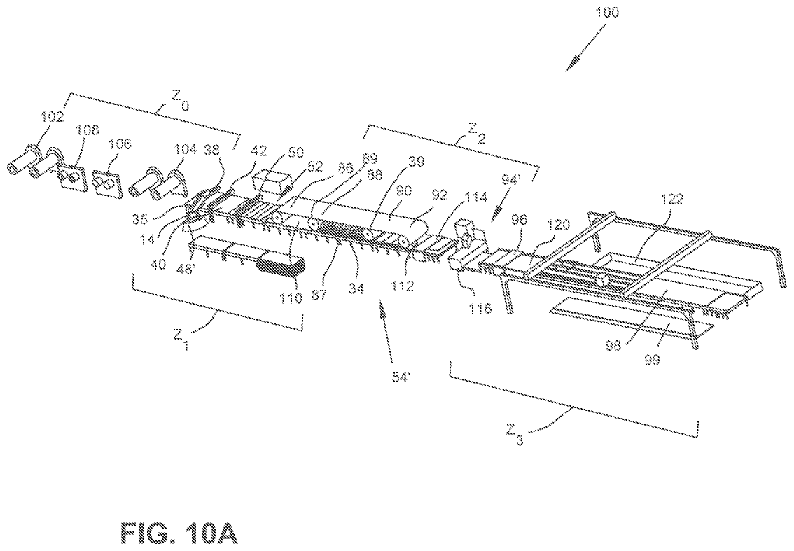

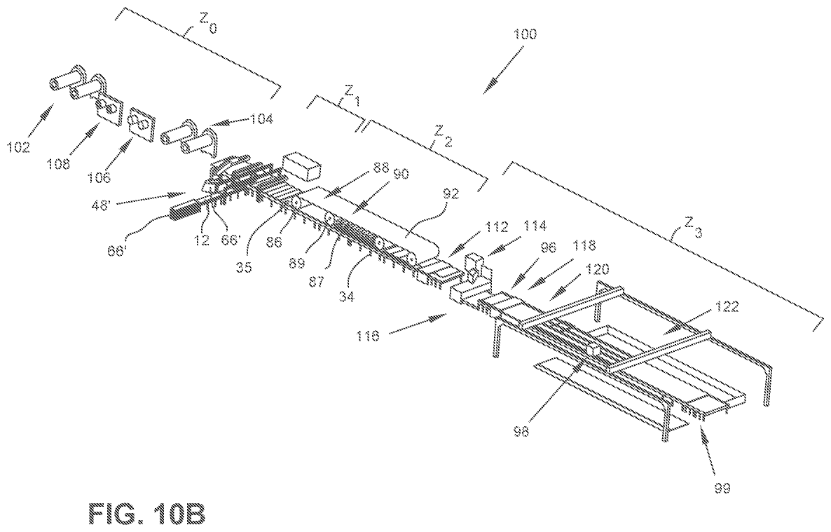

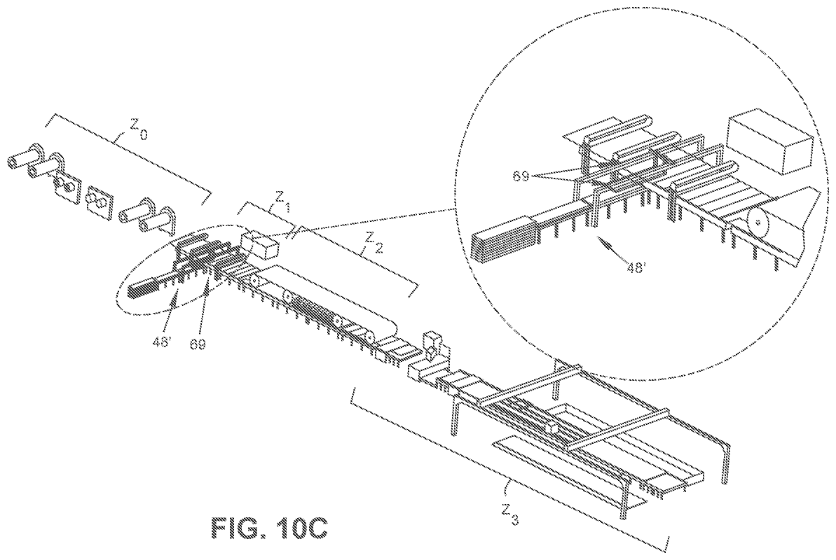

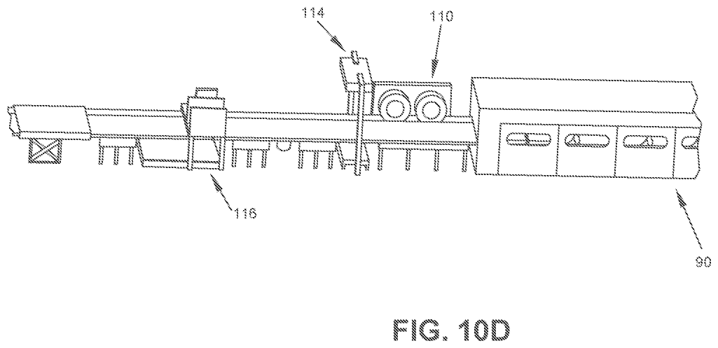

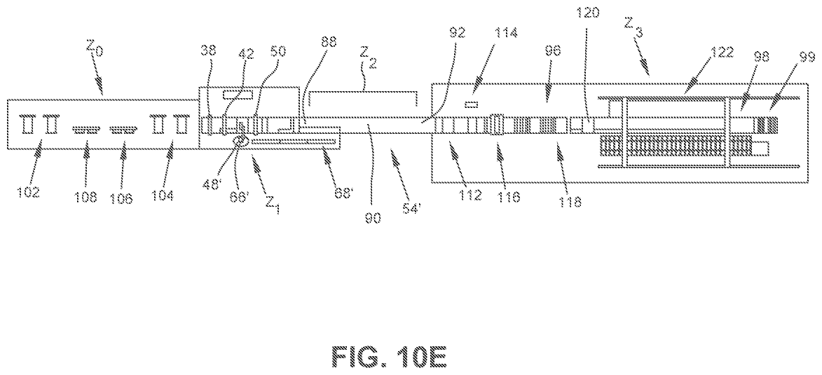

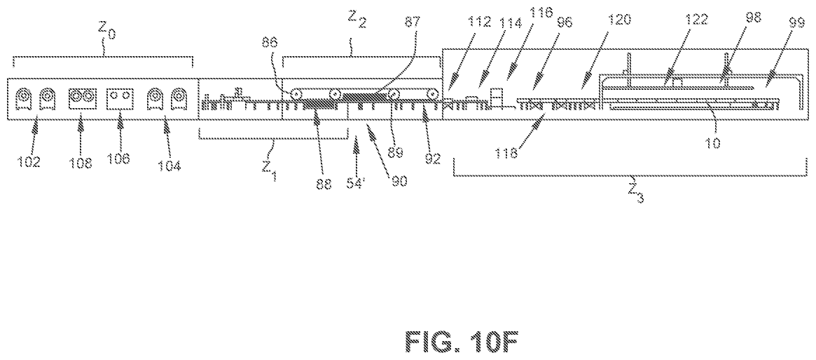

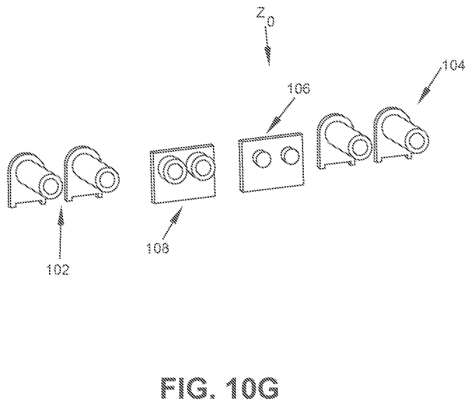

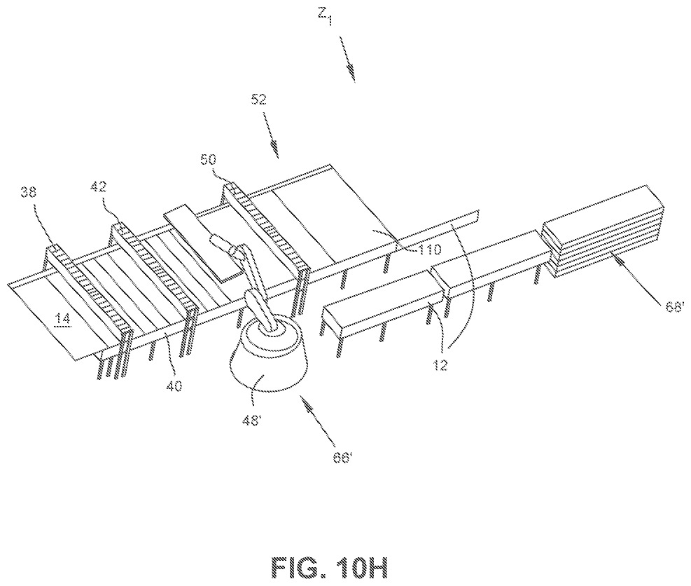

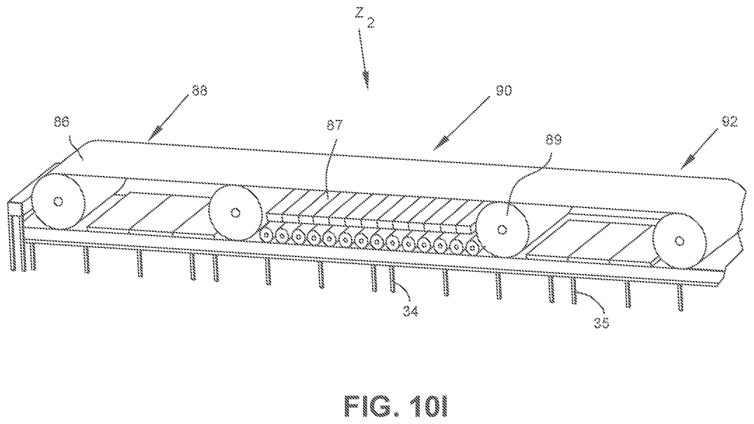

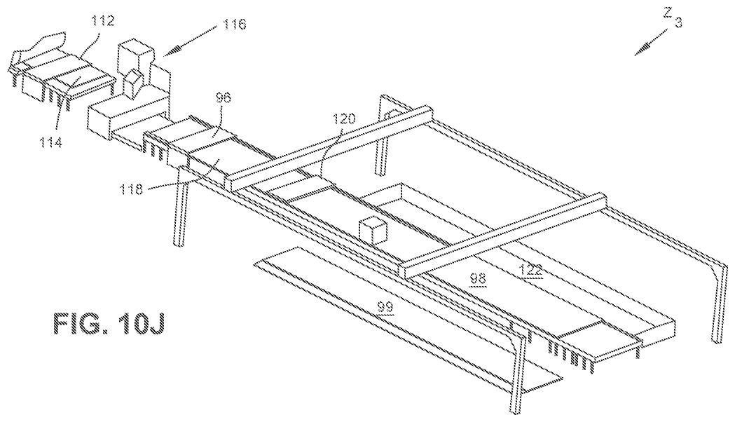

Referring now to FIGS. 10A-10J, a fifth embodiment continuous manufacturing line 100 is disclosed for forming composite structure 10. Manufacturing line 100 includes many components and general similarities to manufacturing line 32 (FIGS. 5 and 6), manufacturing line 60 (FIGS. 7A and 7B), manufacturing line 70 (FIG. 8), and manufacturing line 80 (FIGS. 9A-9F) where like components are denoted with like reference numbers/symbols. Manufacturing line 100 includes zones 1, 2, and 3 (Z₁, Z₂, Z₃) but also includes a zone 0 (Z₀) which may be defined as a materials preparation or handling zone upstream of zone 1 (Z₁). Zone 0 (Z₀) includes a first or interior liner despool station or component 102 for liner material 14, a second or exterior liner despool station or component 104 for liner material 14, and a doubler material despool station or component 106 for doubler material 16. In some embodiments, composite structure 10 may include a scuff material which is provided by a scuff liner despool or component 108. Zone 0 (Z₀) allows people or equipment (e.g., robotic equipment) to prepare the individual materials of composite structure 10 (FIG. 2) for entering conveyor 35 and the components thereof within zones 1, 2, and 3 (Z₁, Z₂, Z₃).

Once the materials are prepared, manufacturing line 100 includes zone 1 (Z₁), which is similar to zone 1 (Z₁) of manufacturing lines 32, 60, 70, 80 disclosed herein. Instead of liner supply 36 (FIG. 5), zone 1 (Z₁) of manufacturing line 100 begins with conveyor 35 receiving liner material 14 from liner despool station 102 or 104. Liner material 14 is wetted with resin from first reciprocator 38 and doubler material 16 from doubler material despool station 106 is applied thereto by doubler supply 40. Doubler material 16 is then wetted with resin from second reciprocator 42, after which, core material 12 from core supply 48′ is applied to the wetted doubler material 16. As shown in FIG. 10B, core supply 48′ includes hopper 66′ and staging area 68′ as disclosed herein. It may be appreciated that the configuration of manufacturing line 100 of FIG. 10B allows for sufficient width of line 100 for maintenance (e.g., maintenance on a double press line). In one embodiment, and as shown in FIG. 10C, core supply 48′ includes a gantry 69 positioned along at least a portion of conveyor 35 and/or hopper 66′ which may allow equipment, such as robotic arms, to facilitate the placement of core material 12 onto conveyor 35. Core material 12 is then wetted with liquid resin from third reciprocator 50 before additional liner material 14 from liner despool station 102 or 104 is applied by liner supply 52 to form the exterior surface of composite structure 10. In one embodiment, manufacturing line 100 includes a scuff supply 110 configured to apply scuff material from scuff liner despool 108 onto liner material 14. In some embodiments, scuff supply 110 may be positioned after compression and curing zone 90 as shown in FIG. 10D and described further herein.

From here, composite structure 10 moves with or along conveyor 35 to zone 2 (Z₂) to receive further processing in the form of heat and/or pressure at station 54′. Station 54′ includes compaction or pressure device 86, heating station 88, compression and curing zone 90, and cooling zone at 92, as disclosed herein with respect to manufacturing line 80 of FIGS. 9A-9F. More particularly, pressure device 86 may initially consolidate composite structure 10 and remove any excess liquid resin before composite structure 10 receives temperature adjustments at stations 88, 90, and 92.

Following cooling zone 92, zone 3 (Z₃) begins with an inspection station 112 which is configured to identify any surface defects on composite structure 10. In some embodiments, as shown in FIG. 10D, zone 3 includes scuff supply 10, wherein the scuff is provided to composite structure 10 either before or after inspection station 112, but following compression and curing of composite structure 10. In such embodiments, zone 0 may be shortened by providing scuff liner despool 108 nearer to scuff supply 110. Following inspection of composites structure 10 at inspection station 112 and/or addition of scuff at scuff supply 110, zone 3 (Z₃) includes a trimming station 94′ configured to trim the ends of composite structure 10 and/or trim or cut composite structure 10 to a predetermined size. More particularly, trimming station 94′ may include a width trim station 114 and a length trim station 116, each of which may include any cutting device such as saws or routers for cutting through composite structure 10. As disclosed herein, the width and/or length of composite structure 10 may be trimmed or cut to predetermined dimensions based on the application of composite structure 10. For example, the length of composite structure 10 may be trimmed or cut to 53 feet when the application of composite structure 10 is side wall 7 of trailer 4 (FIG. 4). After trimming or cutting at station 94′, composite structure 10 may include raw or exposed edges where, for example, raw core material 12 which is exposed to ambient air. The exposed edges may be cleaned and sealed at sealing station 96. In one embodiment, the edges may be sealed by spraying an edge sealant around the entire periphery of composite structure 10 or along any exposed edges, rolling an edge sealant along the exposed edges, or roll coating the edge sealant along the exposed edges. Once the edges are sealed at station 96, composite structure 10 moves along support surface 34 and may go through a further inspection station 118 to identify any internal defects such as voids, delamination, and/or foreign materials. Following inspection station 118, the dimensions (e.g., height, weight, length, thickness) of composite structure 10 may be measured and confirmed at a measurement station 120. If any further trimming or scrap removal is needed, zone 3 (Z₃) includes a scrap removal station 122. Downstream of scrap removal station 122, station 98 conveys the full length of composite structure 10. Finally, at station 99, the trimmed/cut and inspected composite structure 10 is removed from conveyor 35 and moved to any further location depending on the application of composite structure 10. However, it may be appreciated that no further processing steps are needed to complete composite structure 10 once composite structure 10 is removed at station 99 and, instead, composite structure 10 is then ready for installation on cargo vehicle 2 (FIGS. 1A-1C) or for any other final application. In one embodiment, one composite structure 10 is removed at station 99, composite structure(s) 10 may be staged and stacked on pallets in order to move any next location. The configuration of manufacturing line 100 may allow composite structure 10 to be removed from the side of conveyor 35 or composite structure 10 may be removed from the linear end of conveyor 35.

Referring now to FIGS. 11A-11E, a sixth embodiment continuous manufacturing line 130 is disclosed for forming composite structure 10. Manufacturing line 130 includes many components and general similarities to manufacturing line 32 (FIGS. 5 and 6), manufacturing line 60 (FIGS. 7A and 7B), manufacturing line 70 (FIG. 8), manufacturing line 80 (FIGS. 9A-9F), and manufacturing line 100 (FIGS. 10A-10J), where like components are designated with like reference numbers/symbols. Manufacturing line 130 includes zones 0, 1, 2, and 3 (Z₀, Z₁, Z₂, Z₃).

Zone 0 (Z₀) includes a first, upper tier 132 having a first or interior liner despool station or component 102′ for liner material 14. Zone 0 (Z₀) further includes a second, lower tier 134 having a second or exterior liner despool station or component 104′ for liner material 14 and a doubler material despool station or component 106′ for doubler material 16. In some embodiments, composite structure 10 may include a scuff material which is provided by a scuff liner despool or component 108′ of upper tier 132. In some embodiments, the arrangement of the first or interior liner despool station or component 102′, the second or exterior liner despool station or component 104′, the doubler material despool station or component 106′, and the optional scuff liner despool or component 108′ may vary relative to the first, upper tier 132 and the second, lower tier 134. A material loading gantry or crane 140 may assist with the movement and preparation of materials in zone 0.

While first tier 132 is additionally referred to as “upper tier” 132 herein and second tier 134 is additionally referred to as “lower tier” 134 herein, the arrangement of first tier 132 relative to second tier 134 and vice versa may vary. As illustrated, first tier 132 and second tier 134 are positioned in a vertical orientation relative to each other, where first tier 132 is positioned vertically above second tier 134 in the same plane. In other embodiments, first tier 132 and second tier 134 may be positioned in a vertical orientation relative to each other in a laterally offset manner. In other embodiments, first tier 132 and second tier 134 may be horizontally aligned.

Following zone 0, manufacturing line 130 includes zone 1 (Z₁), which is similar to zone 1 (Z₁) of manufacturing lines 32, 60, 70, 80, and 100 disclosed herein. As described further herein, the materials provided in zone 0 meet in zone 1 so that zone 1 is at the same level or orientation as second tier 134 of zone 0. In other embodiments, while the materials provided in zone 0 meet in zone 1, zone 1 may be at the same level or orientation as first tier 132 of zone 0.

Zone 1 of manufacturing line 130 begins with conveyor 35 receiving liner material from liner despool station 102′ at station 136. Liner material 14 is wetted with resin from first reciprocator 38, and doubler material 16 from doubler material despool station 106′ is applied thereto by doubler supply 40, which receives said doubler material from a first overhead system 138. Doubler material 16 is then wetted with resin from second reciprocator 42, after which, core material 12 from core supply 48′ is applied to the wetted doubler material. Core supply 48′ may include a hopper (not shown) and staging area 68′ as disclosed herein. Core material 12 is then wetted with liquid resin from third reciprocator 50 before additional liner material 14 from liner despool station 104′ is applied by liner supply 52 to form the exterior surface of composite structure 10. Liner supply 52 receives said additional liner material 14 from a second overhead system 142. In some embodiments, manufacturing line 130 includes a scuff supply 110 configured to apply scuff material from scuff liner despool 108′ onto liner material 14. Like liner supply 52, scuff supply 110 may receive said scuff material from the second overhead system 142.

Following zone 1 (Z₁), composite structure moves with or along conveyor 35 to zone 2 (Z₂) to receive further processing in the form of heat and/or pressure at station 54′. Station 54′ includes compaction or pressure device 86, heating station 88, compression and curing zone 90, and cooling zone 92, as disclosed herein with respect to manufacturing line 80 of FIGS. 9A-9F and manufacturing line 100 of FIGS. 10A-10J.

Following cooling zone 92 of zone 2 (Z₂), zone 3 (Z₃) begins with inspection station 112 and continues through zone 3 as disclosed herein with respect to manufacturing line 100 of FIGS. 10A-10J. Zone 3 includes, along with first inspection station 112, optional scuff supply 110, width trimming station 114, length trimming station 116, sealing station 96, second inspection station 118, measurement station 120, station 98, at which the full length of composite structure 10 is conveyed, scrap removal station 122, and station 99, at which the trimmed, cut, and sealed composite structure 10 may be removed from manufacturing line 130. In some embodiments, zone 3 (Z₃) may include an additional scrap removal station 144 to remove the scrap resulting from width trimming station 114. In various embodiments, scraps may be shredded to facilitate efficient disposal of scrap at scrap removal station 122 and/or scrap removal station 144.

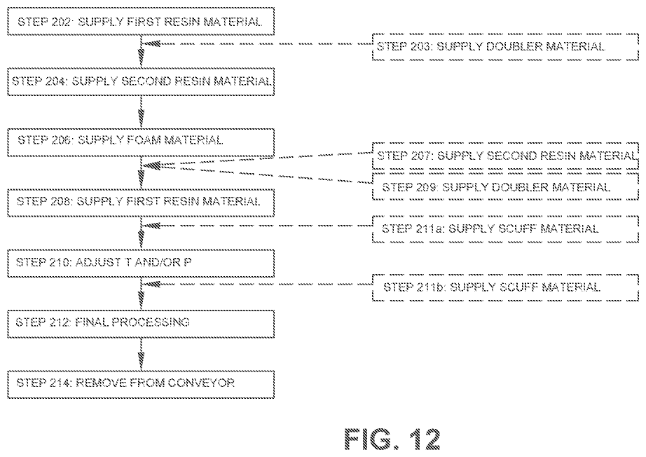

In operation, and according to FIG. 12, while various aspects of manufacturing lines 32, 60, 70, 80, 100 may differ, in general, composite structure 10 is prepared according to fabrication process 30. For example, fabrication process 30 is typically initiated by providing a first resin material such as a solid or precured polymeric resin liner material 14 (Step 202), applying a second resin material such as a liquid or uncured resin material from any of resin supplies or reciprocators 38, 42, 50, 84 (Step 204), applying core material 12 (Step 206), and applying a layer of the first resin material (e.g., liner material 14) to core material 12 (Step 208). As noted herein, fabrication process 30 also may include additional steps to apply doubler material 16 to liner material 14 and/or core material 12. Once the layers/materials of composite structure 10 are provided, Step 210 includes adjusting temperature and/or pressure conditions to process composite structure 10. For example, at station 54, 54′, composite structure 10 may be cured and/or pressed according to predetermined temperature and pressure parameters and based on the final application of composite structure 10. Finally, in Step 212, composite structure 10 receives final processing and, in Step 214, is removed from conveyor 35. As disclosed herein, Step 212 may include a plurality of steps, such as trimming/cutting, edge sealing, inspection(s), and conveyance and/or measurement of the final composite structure 10.

As shown in FIG. 12, fabrication process 30 may include additional steps, depending on the application of composite structure 10. For example, doubler material 16 may be provided at Step 203 between Steps 202 and 204. Additional doubler material 16 may be provided at Step 209 downstream of Step 206 such that doubler material 16 is applied to core material 12. As noted herein, core material 12 may be wetted with a liquid resin from one of reciprocators 38, 42, 50, 84 as shown in Step 207 such that core material 12 is wetted with resin before application of doubler material 16 thereto. While Step 207 is shown upstream of Step 209, it may be appreciated that Step 207 may occur at any time in conjunction with Step 209. As disclosed herein, a scuff material may be applied to as shown in Step 211. More particularly, following Step 208, a scuff material may be applied to the first resin material. Additionally or alternatively, following Step 210, a scuff material may be applied after temperature and/or pressure is applied to composite structure 10. While Step 211 is shown downstream of Step 210, it may be appreciated that Step 211 may occur at any time in conjunction with at least Steps 208 and 210.

It may be appreciated that the speed of conveyor 35 may be the same through zones 0, 1, 2, and 3 (Z₀, Z₁, Z₂, Z₃) of manufacturing lines 32, 60, 70, 80, 100, 130 so as to maintain a continuous process for forming composite structure 10 throughout the duration of fabrication process 30. More particularly, with respect to any of manufacturing lines 32, 60, 70, 80, 100, 130 disclosed herein, the speed of conveyor 35 is a generally non-zero speed which allows for the continuous processing and manufacture of composite structure 10 without breaks or stops in the process. However, in various embodiments, the speed of conveyor 35 may be variable within or between any of the zones, however, the speed, even if variable, is non-zero so as to maintain continuous manufacturing of composite structure 10 compared to batch fabrication methods.

It may be further appreciated that all manufacturing steps of composite structure 10, as disclosed herein with respect to manufacturing lines 32, 60, 70, 80, 100, 130, are part of an in-line, continuous manufacturing process such that composite structure 10 is fully assembled from raw materials and finally processed, including cutting to size, along the length of support surface 34 and conveyor 35 and, as such, there are no secondary processing or manufacturing steps once composite structure 10 is removed from conveyor 35. By allowing the entire formation of composite structure 10 to occur during one, continuous process, fabrication process 30 eliminates any secondary or off-line manufacturing steps to finish composite structure 10. In this way, fabrication process 30 improves cost, time, and materials efficiency by condensing all forming and final processing steps into a single, continuous manufacturing line. Further, the quality of composite structure 10 may be enhanced by automating and controlling fabrication process 30 and by recording data from fabrication process 30 such that adjustments to fabrication process 30 may be made based on such data.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

What is claimed is:

1. A composite structure, comprising:
an outer layer comprised of a first resin material and defining an outermost surface of the composite structure;
an inner layer comprised of the first resin material and defining an innermost surface of the composite structure;
a core material positioned intermediate the outer and inner layers; and
a second resin material in contact with the core material and at least one of the outer layer and the inner layer, wherein the second resin material is different from the first resin material.

2. A method of manufacturing a composite structure, the method comprising:
providing a linear conveyor system having at least a first zone, a second zone, and a third zone, where the first, second, and third zones are linearly aligned with each other;
providing a first layer of precured resin material in the first zone;
providing a core material in the first zone, the core material being configured as foam preforms;
receiving the core material onto the precured resin material in the first zone in a direction transverse to the linear conveyor system;
providing a second layer of precured resin material in the first zone;
receiving the second layer of precured resin material on the foam material in the first zone;
integrally forming the composite structure from the first layer, the core material, and the second layer in the second zone;
cutting the formed composite structure to a predetermined size in the third zone; and
removing the cut composite structure from the linear conveyor in the third zone.

3. The method of claim 2, wherein the precured resin material is a thermoplastic material.

4. The method of claim 2, wherein integrally forming the composite structure includes applying at least one of heat or pressure to the first layer, the core material, and the second layer while the first layer, the core material, and the second layer move together through the second zone.

5. The method of claim 2, wherein the conveyor moves through the first, second, and third zones at a non-zero speed.

6. The method of claim 2, further comprising providing a non-cured resin material in the first zone and applying the non-cured resin material to at least the core material.

7. A method of forming a composite structure, the method comprising:
providing a first layer of a thermoplastic resin material;
providing discontinuous core materials onto the first layer;
providing a second layer of the thermoplastic resin material onto the core materials;
providing a thermoset resin material to at least one of the first layer, the second layer, or the core materials, and wherein excess quantities of the thermoset resin material not provided to at least one of the first layer, the second layer, or the core materials are not recycled; and
curing the thermoset resin material separately from curing the thermoplastic resin material to integrally form the composite structure from the first layer, the core material, the second layer, and the thermoset resin material.

8. The method of claim 7, wherein the discontinuous core materials are a plurality of discrete core panels positioned transversely to a direction of the first layer.

9. The method of claim 8, further comprising:
providing a conveyor for directly receiving the first layer; and
moving the conveyor at a predetermined, non-zero speed along a linear movement axis;
wherein providing the discontinuous core materials includes positioning the discrete core panels transversely to the linear movement axis of the conveyor.

10. The method of claim 8, wherein providing the discontinuous core materials includes robotically providing the plurality of discrete core panels onto the first layer.

11. The method of claim 7, further comprising:
providing a thermoset resin supply;
wherein providing the thermoset resin material to at least one of the first layer, the second layer, or the core materials includes spraying the thermoset resin material from the thermoset resin supply onto at least one of the first layer, the second layer, or the core materials, and the excess quantities of the thermoset resin material are not recirculated to the thermoset resin supply.

12. The method of claim 7, further comprising:
cutting the formed composite structure to a predetermined size; and
sealing edges of the cut composite structure where exposed core materials are present.

13. The method of claim 12, further comprising:
providing a conveyor for directly receiving the first layer;
moving the conveyor at a predetermined, non-zero speed along a linear movement axis; and
inspecting the formed composite structure while the formed composite structure is moving on the conveyor at the predetermined, non-zero speed.

14. A method of forming a composite structure, the method comprising:
providing a manufacturing surface having a first direction;
providing a first layer of resin material on the manufacturing surface;
providing discontinuous core materials onto the first layer;
providing a second layer of resin material onto the core materials, wherein excess quantities of the resin material not provided to at least one of the first layer, the second layer, or the core materials are not recycled;
curing the first layer of resin material and the second layer of resin material to form a composite material;
removing the composite material from the manufacturing surface; and
maintaining the first layer of resin, the core materials, and the second layer of resin material in the first direction when forming the composite material, wherein the composite material is removed from the manufacturing surface while extending in the first direction.
